(19) United States
(12) Patent Application Publication
(10) Pub. No.: US 2018/0227734 A1
(43) Pub. Date: Aug. 9, 2018

(54) METHOD AND APPARATUS FOR PROXIMITY COMMUNICATIONS USING CHANNEL AGGREGATION

(71) Applicant: ELECTRONICS AND TELECOMMUNICATIONS RESEARCH INSTITUTE, Daejeon (KR)

(72) Inventors: Jae Seung LEE, Daejeon (KR); Moon-Sik LEE, Daejeon (KR); Yeong Jin KIM, Daejeon (KR); Young-Hoon KIM, Daejeon (KR); Hoo Sung LEE, Sejong-si (KR)

(21) Appl. No.: 15/890,521

(22) Filed: Feb. 7, 2018

(30) Foreign Application Priority Data
Feb. 7, 2017 (KR) 10-2017-0016634
Feb. 7, 2017 (KR) 10-2017-0016669
Jun. 20, 2017 (KR) 10-2017-0077967
Jun. 20, 2017 (KR) 10-2017-0077980

(51) Int. Cl. H04W 4/80; H04W 72/04; H04W 76/10

(52) U.S. Cl. CPC H04W 4/80; H04Q 2213/13208; H04W 76/10; H04W 72/04

(57) ABSTRACT

A proximity communication method and apparatus using a link adaptation. A transmitter establishes a link that is configured using a channel aggregation by performing an association with a receiver, and performs a link adaptation that changes the channel aggregation with respect to the link in response to transmitting data to the receiver using the link.

### CROSS-REFERENCE TO RELATED APPLICATION(S)

This application claims the priority benefit of Korean Patent Application Nos. 10-2017-0016634 and 10-2017016669, filed on Feb. 7, 2017, and Korean Patent Application Nos. 10-2017-0077967 and 10-2017-0077980, filed on Jun. 20, 2017, in the Korean Intellectual Property Office, the disclosures of which are incorporated herein by reference for all purposes.

### BACKGROUND

### 1. Field

One or more example embodiments of the following description relate to a proximity communication technique using a channel aggregation.

### 2. Description of Related Art

Transmission techniques in a frequency band of 60 gigahertz (GHz), such as 802.15.3c technique, support a transmission using a single channel and do not support a channel bonding or a channel aggregation that uses a plurality of channels. The 802.15.3e technique supports a channel bonding that is a technique for achieving a relatively high throughput in proximity communication. However, the 802.15.3e technique does not support a channel aggregation that exhibits a relatively excellent performance compared to the channel boding.

### SUMMARY

At least one example embodiment provides a method and apparatus that may establish a link using a channel aggregation in proximity communication and may provide high data rate at a low complexity.

At least one example embodiment also provides a method and apparatus that may establish a link further suitable for a communication environment using various types of channel aggregation patterns.

At least one example embodiment also provides a method and apparatus that may be compatible with existing techniques by expanding a preamble structure according to a related art through introduction of a channel aggregation and using the expanded preamble structure.

At least one example embodiment also provides a method and apparatus that may adjust a data transmission rate to be suitable for a change in a communication environment by performing a link adaptation in a data transmission phase using a channel aggregation and without performing a separate additional modulation and coding scheme (MCS) negotiation procedure.

At least one example embodiment also provides a method and apparatus that may perform signaling of information associated with a channel aggregation by reusing a frame structure disclosed in the existing 802.15.3e technique and may achieve compatibility between a terminal supporting the channel aggregation and a terminal not supporting the channel aggregation.

According to an aspect of at least one example embodiment, there is provided a proximity communication method by a transmitter, the method including transmitting a beacon frame to a receiver using a default channel; and establishing a link that is configured using a channel aggregation by performing an association with the receiver in response to receiving an association request signal from the receiver.

A first single channel and a second single channel may be aggregated by the channel aggregation.

A first bonded channel and a second bonded channel may be aggregated by the channel aggregation and the first bonded channel and the second bonded channel may be generated by bonding of two single channels.

A first bonded channel, a second bonded channel, and a third bonded channel may be aggregated by the channel aggregation, and the first bonded channel, the second bonded channel, and the third bonded channel may be generated by bonding of two single channels.

A fourth bonded channel and a fifth bonded channel may be aggregated by the channel aggregation, and the fourth bonded channel and the fifth bonded channel may be generated by bonding of three single channels.

The preamble in the frame transmitted after the link establishment may be included in each of frequency segments corresponding to the respective single channels or bonded channels aggregated by the channel aggregation.

The preamble may be repeated a number of times corresponding to a number of single channels aggregated in the bonded channel in each of the frequency segments.

The preamble may include a start frame delimiter (SFD) field, and the SFD field may include a value indicating a channel aggregation pattern of the channel aggregation.

According to an aspect of at least one example embodiment, there is provided a proximity communication method by a receiver, the method including receiving a beacon frame from a transmitter using a default channel; transmitting an association request signal to the transmitter in response to the beacon frame; and establishing a link that is configured using a channel aggregation by performing an association with the transmitter in response to receiving an association response signal from the transmitter.

According to an aspect of at least one example embodiment, there is provided a non-transitory computer-readable recording medium storing instructions that, when executed by a processor, cause the processor to perform the proximity communication method.

According to an at least one example embodiment, there is provided a proximity communication apparatus including at least one processor. The processor is configured to transmit a beacon frame to a receiver using a default channel, and to establish a link that is configured using a channel aggregation by performing an association with the receiver in response to receiving an association request signal from the receiver.

A first single channel and a second single channel may be aggregated by the channel aggregation.

A first bonded channel and a second bonded channel may be aggregated by the channel aggregation and the first bonded channel and the second bonded channel may be generated by bonding of two single channels.

A first bonded channel, a second bonded channel, and a third bonded channel may be aggregated by the channel aggregation, and the first bonded channel, the second bonded channel, and the third bonded channel may be generated by bonding of two single channels.

A fourth bonded channel and a fifth bonded channel may be aggregated by the channel aggregation, and the fourth bonded channel and the fifth bonded channel may be generated by bonding of three single channels.

The preamble in the frame transmitted after the link establishment may be included in each of frequency segments corresponding to the respective single channels or bonded channels aggregated by the channel aggregation.

The preamble may be repeated a number of times corresponding to a number of single channels aggregated in the bonded channel in each of the frequency segments.

The preamble may include an SFD field, and the SFD field may include a value indicating a channel aggregation pattern of the channel aggregation.

According to an aspect of at least one example embodiment, there is provided a proximity communication method by a transmitter, the method including establishing a link that is configured using a channel aggregation by performing an association with a receiver; and performing a link adaptation that changes the channel aggregation with respect to the link in response to transmitting data to the receiver using the link.

The performing of the link adaptation may include performing the link adaptation by changing a spreading factor.

The performing of the link adaptation may include performing the link adaptation by changing a value of an SFD field indicating a channel aggregation pattern and the spreading factor.

The performing of the link adaptation may include performing the link adaptation by changing a number of frequency segments.

The performing of the link adaptation may include changing the number of frequency segments by changing a value of an SFD field indicating a channel aggregation pattern that indicates the number of frequency segments.

The performing of the link adaptation may include changing a link that is configured using a channel aggregation of a first single channel and a second single channel with a link that is configured using the second single channel.

The performing of the link adaptation may include changing a link that is configured using a channel aggregation of a first bonded channel and a second bonded channel with a link that is configured using the first bonded channel.

The performing of the link adaptation may include changing a link that is configured using a channel aggregation of a first bonded channel, a second bonded channel, and a third bonded channel with a link that is configured using a channel aggregation of the first bonded channel and the second bonded channel or a link that is configured using the first bonded channel.

The performing of the association may include transmitting information regarding whether a channel aggregation is supported and information associated with a channel aggregation pattern to the receiver.

The performing of the association may include transmitting information regarding whether the channel aggregation is supported and information associated with the channel aggregation pattern to the receiver using a single-carrier (SC) channel aggregation field and an SC supported channel aggregation pattern field.

According to an aspect of at least one example embodiment, there is provided a proximity communication method by a receiver, the method including establishing a first link that is configured using a channel aggregation by performing an association with a transmitter; and receiving data from the transmitter using a second link of which the channel aggregation is changed through a link adaptation performed with respect to the first link.

The link adaptation may be performed by changing a spreading factor.

The spreading factor may be changed by changing a value of an SFD field indicating a channel aggregation pattern and the spreading factor.

The link adaptation may be performed by changing a number of frequency segments.

The number of frequency segments may be changed by changing a value of an SFD field indicating a channel aggregation pattern that indicates the number of frequency segments.

The receiving of the data may include decoding a preamble that is included in a frequency segment corresponding to a default channel; acquiring information associated with the channel aggregation pattern of the changed channel aggregation based on the acquired value of the SFD field that is acquired as a result of the decoding; and receiving a subsequent frequency segment based on information associated with the channel aggregation pattern.

According to an aspect of at least one example embodiment, there is provided a non-transitory computer-readable recording medium storing instructions that, when executed by a processor, cause the processor to the proximity communication method.

According to an aspect of at least one example embodiment, there is provided a proximity communication apparatus including at least one processor. The processor is configured to establish a link that is configured using a channel aggregation by performing an association with a receiver, and to perform a link adaptation that changes the channel aggregation with respect to the link in response to transmitting data to the receiver using the link.

The processor may be configured to perform the link adaptation by changing a spreading factor.

The processor may be configured to perform the link adaptation by changing a number of frequency segments.

According to example embodiments, it is possible to establish a link by applying a channel aggregation in proximity communication and to transmit high rate data at a low complexity.

Also, according to example embodiments, it is possible to establish a link further suitable for a communication environment using various types of channel aggregation patterns.

Also, according to example embodiments, it is possible to be compatible with existing techniques by expanding a preamble structure according to a related art through introduction of a channel aggregation and using the expanded preamble structure.

Also, according to example embodiments, it is possible to adjust a data transmission rate to be suitable for a change in a communication environment by performing a link adaptation in a data transmission phase using a channel aggregation and without performing a separate additional modulation and coding scheme (MCS) negotiation process.

Also, according to example embodiments, it is possible to perform signaling of information associated with a channel aggregation by reusing a frame structure disclosed in the existing 802.15.3e technique and may achieve compatibility between a terminal supporting the channel aggregation and a terminal not supporting the channel aggregation.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration of a system for performing a proximity communication using a channel aggregation according to an example embodiment;

FIG. 2 illustrates an association process between a transmitter and a receiver and a process of transmitting and receiving data therebetween according to an example embodiment;

FIG. 3A is a flowchart illustrating a proximity communication method performed by a transmitter using a channel aggregation according to an example embodiment;

FIG. 3B is a flowchart illustrating a proximity communication method performed by a receiver using a channel aggregation according to an example embodiment;

FIG. 4A illustrates a type of a channel bonding according to the related art;

FIG. 4B illustrates a type of a channel bonding based on an expanded channel frequency band according to the related art;

FIG. 4C illustrates a type of a channel aggregation pattern about channels based on an expanded frequency according to an example embodiment;

FIG. 5A is a flowchart illustrating a proximity communication method by a transmitter for changing a channel aggregation by performing a link adaptation according to an example embodiment;

FIG. 5B is a flowchart illustrating a proximity communication method by a receiver for changing a channel aggregation by performing a link adaptation according to an example embodiment;

FIG. 6 illustrates a type of a channel aggregation pattern according to an example embodiment.

FIG. 7A illustrates a structure of a preamble according to the related art;

FIG. 7B illustrates a structure of a preamble based on a channel aggregation according to an example embodiment;

FIG. 7C illustrates a structure of a preamble based on a channel aggregation using a bonded channel according to an example embodiment;

FIG. 8A illustrates a structure of a single-carrier (SC) channel aggregation field and an SC supported channel aggregation pattern field according to an example embodiment;

FIG. 8B illustrates a structure of an SC supported channel aggregation pattern field according to an example embodiment; and

FIG. 9 is a diagram illustrating a configuration of a transmitter and a receiver according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments are described with reference to the accompanying drawings. Herein, like reference numerals refer to like elements throughout and a repeated description related thereto is omitted here.

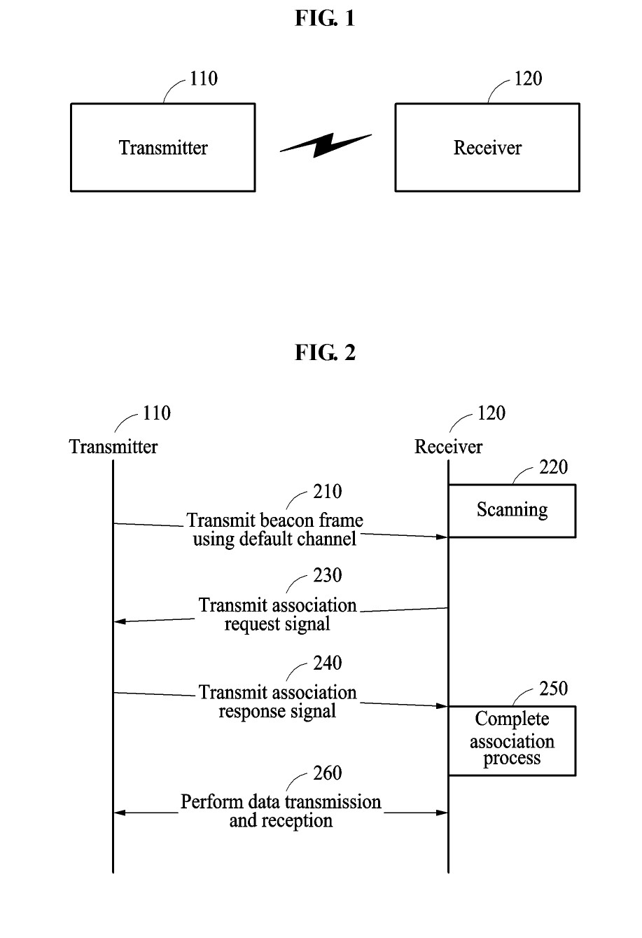

FIG. 1 is a diagram illustrating a configuration of a system for performing a proximity communication using a channel aggregation according to an example embodiment.

According to an example embodiment, a transmitter 110 and a receiver 120 may perform a proximity communication using an associated link and a channel aggregation. Here, the proximity communication may refer to a communication within a close distance of, for example, 10 cm.

A channel bonding is a method of grouping a plurality of single channels and using the plurality of single channels as a single channel and may use even a guard band between the single channels. The channel aggregation is a method of grouping and thereby using a plurality of single channels or bonded channels regardless of whether they are adjacent to each other. Here, a guard band between channels is not used.

In the case of the channel bonding, an implementation complexity increases since a wideband transmission needs to be performed using a single radio frequency (RF) chain or a separate frequency domain equalization (FDE) needs to be processed. On the contrary, since the channel aggregation does not require such processing, an implementation complexity of the channel aggregation may decrease compared to that of the channel bonding. The transmitter 110 and the receiver 120 may perform a high rate communication and may achieve a low complexity using a channel aggregation about a plurality of channels in a close, that is, proximate distance.

According to an example embodiment, the transmitter 110 and the receiver 120 may perform a proximity communication using a channel aggregation of various channel aggregation patterns. Currently, a 60 gigahertz (GHz) regulation has changed to allow a more number of channels to be available in some countries, for example, the United States. Thus, various types of channel aggregation patterns may be used. Since various types of channel aggregation patterns are selectable, the transmitter 110 and the receiver 120 may use a channel aggregation pattern suitable for various communication environments.

The transmitter 110 and the receiver 120 may perform a proximity communication using a preamble, for example, a preamble, modified for a channel aggregation. The preamble may be in a format in which a preamble structure disclosed in the 802.15.3e technique is expanded. The preamble may be provided in various formats based on a channel aggregation pattern.

The transmitter 110 may signal a type of a channel aggregation pattern used for a data transmission using a start frame delimiter (SFD) field expanded for the channel aggregation to the receiver 120. The SFD field according to an example embodiment is included in the preamble and the preamble is included in a physical layer (PHY) frame. Information associated with the channel aggregation pattern is provided to the receiver 120 using the SFD field. Thus, there is no need to change a PHY frame structure of the 802.15.3e technique. As described above, a backward compatibility issue may be solved by minimizing a change about the PHY frame structure of the existing 802.15.3e technique.

When the channel bonding is used and the link adaptation is needed, a transmission rate may be changed by adjusting a spreading factor. However, the number of the bonded channel cannot be changed in a data transmission phase. Here, the link adaptation indicates adapting a link to be suitable for a communication environment.

According to an example embodiment, the transmitter 110 and the receiver 120 may perform the link adaptation even in the data transmission phase using a channel aggregation and without performing a separate additional modulation and coding scheme (MCS) negotiation process. Through this, a data transmission speed may be quickly adapted to be suitable for a change in a communication environment.

According to an example embodiment, the transmitter 110 may perform signaling of information associated with a channel aggregation by reusing a frame structure of the existing 802.15.3e technique. Through this, a compatibility issue between a terminal supporting the channel aggregation and a terminal not supporting the channel aggregation may be solved.

A proximity communication method according to an example embodiment may be applicable to the 802.15.3e technique. The 802.15.3e technique refers to a technique that enables, for example, ultra high speed multimedia data downloading in response to an access of a user tag to a kiosk, a touch gate, and the like.

The transmitter 110 or the receiver 120 may refer to an electronic product that supports the proximity communication. For example, the transmitter 110 or the receiver 120 may include an electronic product, such as a mobile phone, a camera, a television (TV), a refrigerator, etc., a vehicle, and the like. The transmitter 110 may be referred to as a pairnet coordinator (PRC). The receiver 120 may also be referred to as a wireless device (DEV) or a pairnet DEV (PRDEV).

The transmitter 110 may modulate a specific field when a PHY frame is being generated. The PHY frame may be classified into two types based on a modulation scheme. The modulation scheme may be an on-off keying (OOK) modulation scheme or a single carrier (SC) modulation scheme. The OOK modulation scheme may be referred to as a low complexity (LC) modulation scheme. The PHY frame to which the OOK modulation scheme is applied may be referred to as an LC PHY frame or an OOK PHY frame.

FIG. 2 illustrates an association process between a transmitter and a receiver and a process of transmitting and receiving data therebetween according to an example embodiment.

Once an association procedure between the transmitter 110 and the receiver 120 is completed in a proximity communication between the transmitter 110 and the receiver 120, a data communication is performed. The association process may refer to a process of setting a communication environment, such as a communication target, a selection of a PHY mode, or a selection of a channel aggregation pattern.

According to an example embodiment, in operation 210, the transmitter 110 may transmit a beacon frame including information associated with a specific channel aggregation pattern to the receiver 120 using a predetermined default channel. In operation 220, the receiver 120 may acquire information associated with a channel aggregation pattern available for data transmission and reception with the corresponding transmitter 110 through a scanning process.

If the receiver 120 desires an association with the corresponding transmitter 110, the receiver 120 may transmit an association request message including information associated with the specific channel aggregation pattern supported by the receiver 120 to the transmitter 110 in response to the received beacon frame in operation 230. In operation 240, the transmitter 110 may transmit an association response message corresponding to the association request to the receiver 120. The association response message may include specific channel aggregation pattern information to be used for data transmission between the transmitter 110 and the receiver 120. Once the receiver 120 receives the association response message from the transmitter 110, the receiver 120 may complete the association procedure and may establish a link for data communication in operation 250. In operation 260, the receiver 120 may exchange a data frame with the transmitter 110 through the link established by a channel aggregation that uses the corresponding channel aggregation pattern.

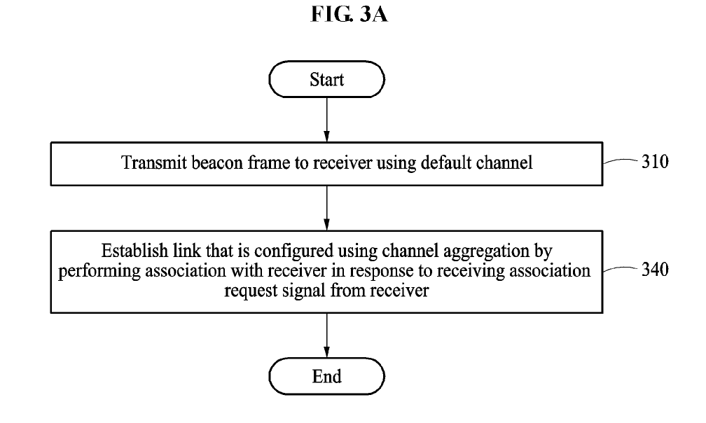

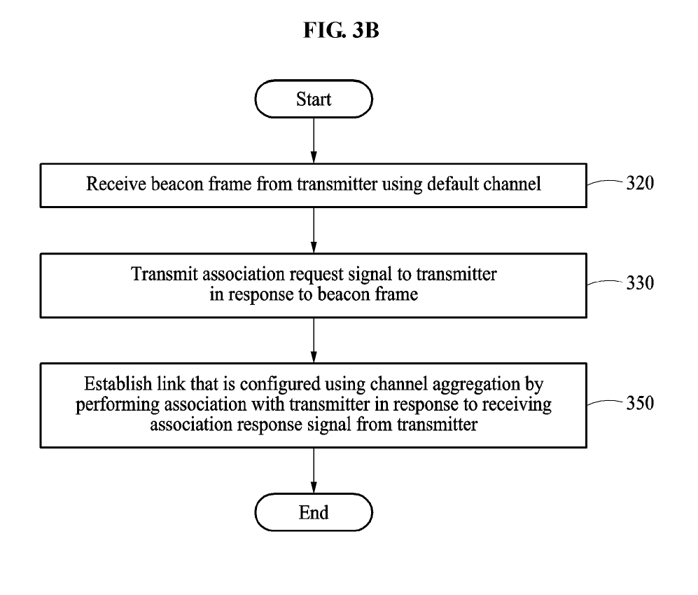

FIG. 3A is a flowchart illustrating a proximity communication method performed by a transmitter using a channel aggregation according to an example embodiment.

A process in which a transmitter establishes a link with a receiver using a channel aggregation will be described with reference to FIG. 3A. Referring to FIG. 3A, in operation 310, the transmitter transmits a beacon frame to the receiver using a predetermined default channel. The beacon frame includes information associated with a channel aggregation pattern supported by the corresponding transmitter. The beacon frame may include information regarding whether the channel aggregation is used and a channel aggregation pattern used for the channel aggregation.

According to an example embodiment, in response to receiving an association request signal from the receiver, the transmitter establishes a link that is configured using the channel aggregation by performing an association with the receiver in operation 340. The transmitter and the receiver may perform a channel aggregation using the beacon frame, the association request, and information regarding a channel aggregation pattern included in an association response message.

FIG. 3B is a flowchart illustrating a proximity communication method performed by a receiver using a channel aggregation according to an example embodiment.

A process in which a receiver establishes a link with a transmitter using a channel aggregation will be described with reference to FIG. 3B. Referring to FIG. 3B, in operation 320, the receiver receives a beacon frame including information associated with a channel aggregation pattern supported by a corresponding transmitter from the transmitter, using a predetermined default channel. The receiver may acquire information associated with the channel aggregation pattern supported by the corresponding transmitter, included in the beacon frame. If the receiver desires an association with the corresponding transmitter, the receiver may perform operation 330.

According to an example embodiment, in operation 330, the receiver transmits an association request signal including information associated with a specific channel aggregation pattern supported by the receiver to the transmitter in response to the beacon frame. The transmitter may transmit an association response signal to the receiver in response to the association request signal. An association response message may include information associated with the specific channel aggregation pattern to be used for data transmission between the transmitter and the receiver.

According to an example embodiment, in operation 350, the receiver may establish a link that is configured using the channel aggregation by performing an association with the transmitter and may in response to receiving the association response signal from the transmitter. The link may be established based on the beacon frame, the association request, and information associated with the channel aggregation pattern that is included in the association response message.

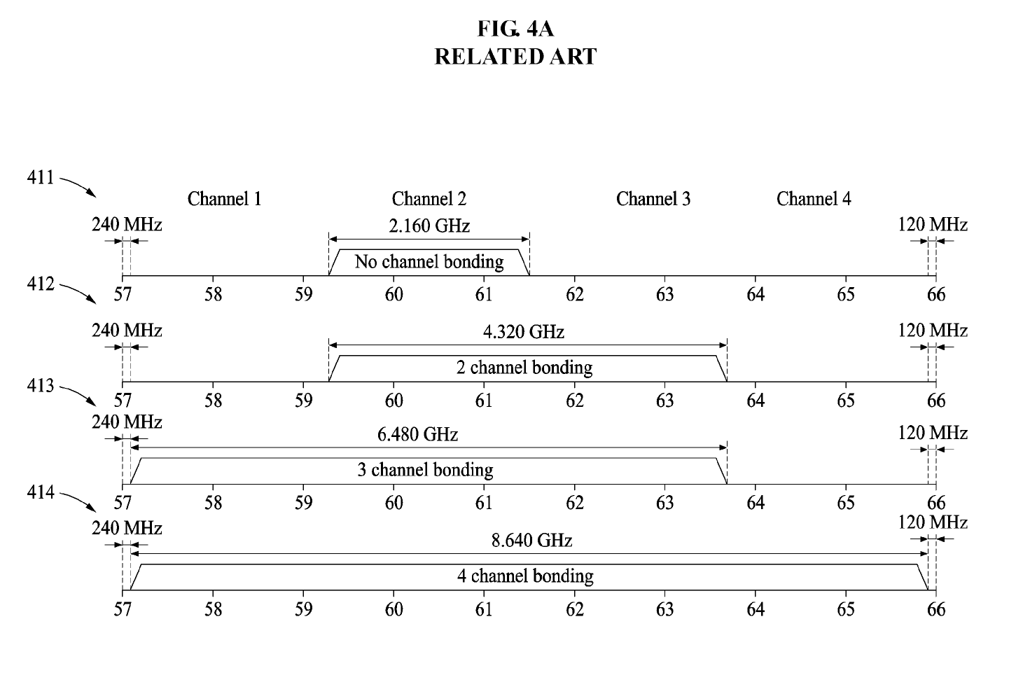

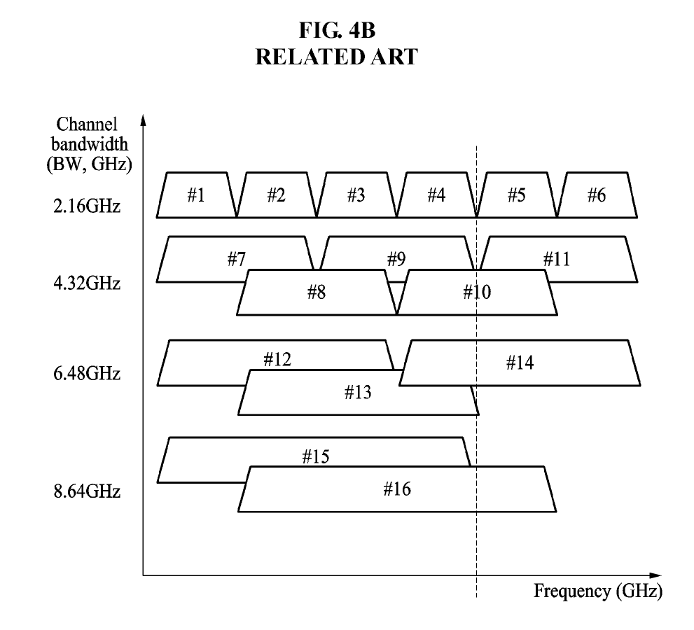

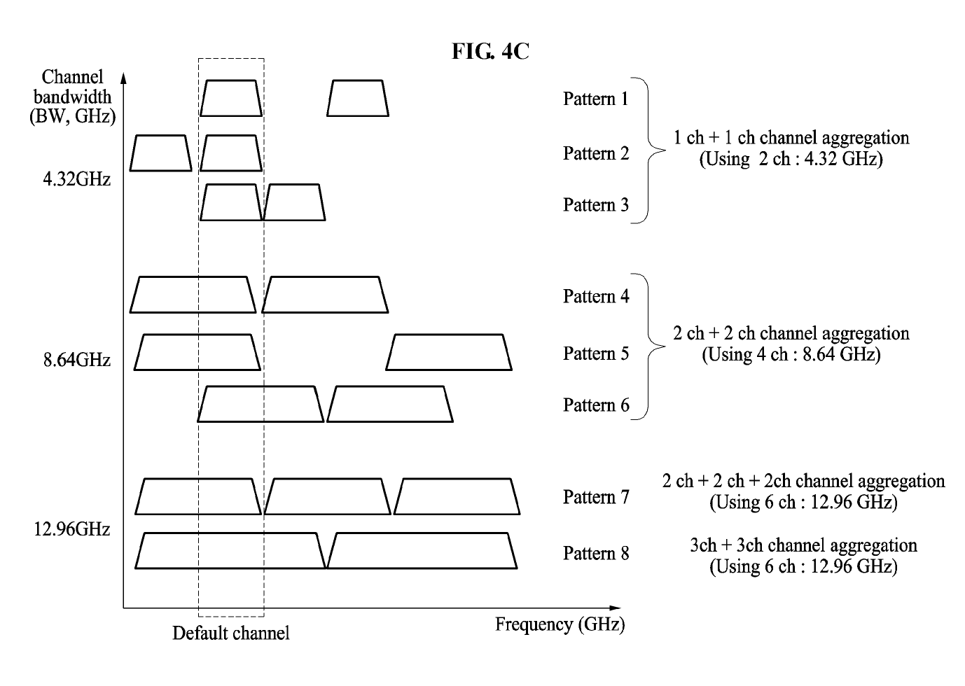

FIG. 4A illustrates a type of a channel bonding according to the related art, and FIG. 4B illustrates a type of a channel bonding based on an expanded channel frequency band according to the related art.

A transmitter may transmit data through a wideband by bonding a plurality of channels using a channel bonding. An OOK PHY may support a channel bonding of up to four channels. Referring to FIG. 4A, a 60 GHz band is divided into four single channels of 2.16 GHz. The four single channels may be identified as a channel 1, a channel 2, a channel 3, and a channel 4.

A channel state 411 represents a channel used for a conventional communication technique. The conventional communication technique uses the 60 GHz band in a state in which the 60 GHz band is divided into the four single channels as shown in the channel state 411. In the channel state 411, a single channel is 2.16 GHz and, for example, 1.76 GHz is used.

To support a higher rate, a channel bonding may be used. Channel states 412, 413, and 414 represent channel states each in which the channel bonding is applied.

In the channel state 412, a channel 6 may be generated by applying the channel bonding to the channel 2 and the channel 3. In the channel state 413, a channel 8 may be generated by applying the channel bonding to the channel 1, the channel 2, and the channel 3. In the channel state 414, a channel 9 may be generated by applying the channel bonding to the channel 1, the channel 2, the channel 3, and the channel 4.

A specific single channel may be set to be included in all of the bonded channels as a default channel. For example, referring to FIG. 4A, the channel 2 may be set as the default channel and may be included in all of the channel states 412, 413, and 414 each to which the channel bonding is applied. The receiver may further quickly discover the transmitter by listening to the default channel at all times. If the default channel is not used, the receiver needs to scan all of the single channels and a further long discovery time is required.

Settings may be performed so that, if only a single channel is used, only the default channel, for example, the channel 2, may be used, and so that specific channels may be used when the channel bonding is performed. For example, if bonding two channels (also, referred to as 2 channel bonding), the channel 2 and the channel 3 may be used, if bonding three channels (also, referred to as 3 channel bonding), the channel 1, the channel 2, and the channel 3 may be used, and if bonding four channels (also, referred to as 4 channel bonding), the channel 1, the channel 2, the channel 3, and the channel 4 may be used.

In the case of performing the channel bonding as described above, once a number of channels to be bonded between two terminals is determined, which number channels are to be used for data transmission may be determined without performing a separate negotiation process or signaling. As described above, channels to be used for the channel banding may be predetermined based on the number of channels to be bonded. Accordingly, signaling overhead about a type of a channel to be bonded may decrease. For example, it may be assumed that, when the communication range is assumed to be less than 10 cm, all the channels are available between two terminals, for example, a kiosk and a user terminal, at all times without inference from a neighboring terminal. Accordingly, the above method may be used without decreasing a channel use efficiency.

Currently, in countries such as the United States, 60 GHz regulation is changed. Accordingly, a number of channels in an unlicensed frequency band available in the 60 GHz band is changed from four channels to six channels. Also, in the 802.11ay technique, overlapped channelization is introduced. FIG. 4B illustrates a channelization according to an expanded frequency band. Referring to FIG. 4B, a right portion based on a dotted line represents an added unlicensed frequency band in the 60 GHz band. The unlicensed frequency band may include channels #1 through #16.

The channel bonding may reduce a number of RF chains and may use a guard band between single channels. However, according to an increase in a number of channels to be bonded, a further large amount of wideband transmission needs to be processed in a single RF channel, which leads to increasing a complexity. Also, in the case of OOK PHY, a degradation in a transmission performance is relatively small without performing a separate FDE, up to 2 channels. However, when bonding three or more channels, the degradation in the transmission performance may increase and thus, a separate processing process, such as FDE, is required. Accordingly, a configuration complexity increases.

FIG. 4C illustrates a type of a channel aggregation pattern about channels based on an expanded frequency according to an example embodiment.

According to an example embodiment, a transmitter and a receiver may perform a proximity communication using a channel aggregation of various channel aggregation patterns. Bonded channels each in which two single channels are bonded may be aggregated or bonded channels each in which maximum three single channels are bonded may be aggregated by a channel aggregation. As described above, the channel aggregation may decrease an amount of wideband transmission to be processed in a single RF chain by limiting a number of channels to be bonded. Also, the channel aggregation may maintain a degradation in transmission performance to be at a low level without performing FDE by limiting the number of channels to be bonded. Here, a single RF chain may be required for each single frequency segment to be transmitted.

For example, in the case of transmission using four channels, a relatively excellent transmission performance may be achieved when a channel aggregation (2 ch+2 ch) is applied to two bonded channels each in which two single channels are bonded rather than when using a single bonded channel in which four single channels are bonded. Also, in the case in which a channel aggregation (2 ch+2 ch) is applied to two bonded channels each in which two single channels are bonded, if two non-adjacent bonded channels are aggregated, interference between the bonded channels may decrease.

For example, if a single bonded channel in which six channels are bonded is used to use all of the six channels, the transmission performance may be degraded or the complexity may increase. On the contrary, if three bonded channels (2 ch+2 ch+2 ch) each in which two single channels are bonded are aggregated, or if two bonded channels (3 ch+3 ch) each in which three single channels are bonded are aggregated, all of the six channels may be readily used.

Various types of channel aggregation patterns will be described with reference to FIG. 4C. All of the channel aggregation patterns may include a default channel, for example, a channel 2.

According to an example embodiment, a first single channel and a second single channel may be aggregated by a channel aggregation. As a result of aggregating the two single channels, a bandwidth of 4.32 GHz may be used. Patterns 1, 2, and 3 may be a pattern (1 ch+1 ch) for bonding two single channels. In particular, the pattern 1 may reduce interference between channels by bonding non-adjacent channels.

According to an example embodiment, a first bonded channel and a second bonded channel each in which two single channels are bonded may be aggregated by a channel aggregation. A bandwidth of 8.64 GHz may be used as a result of aggregating the two bonded channels. Patterns 4, 5, and 6 may be a pattern (2 ch+2 ch) for bonding two bonded channels each in which two single channels are bonded. In a country that allows only four channels, the pattern 5 and the pattern 6 may be unavailable. In particular, the pattern 5 may reduce interference between channels by aggregating non-adjacent bonded channel.

According to an example embodiment, a first bonded channel, a second bonded channel, and a third bonded channel each in which two single channels are bonded may be aggregated by a channel aggregation. A bandwidth of 12.96 GHz may be used as a result of aggregating the three bonded channels. A pattern 7 is a channel aggregation pattern that uses all of the six single channels and is a pattern (2 ch+2 ch+2 ch) for aggregating three bonded channels each in which two single channels are bonded.

According to an example embodiment, a fourth bonded channel and a fifth bonded channel generated by bonding three single channels may be aggregated by a channel aggregation. A bandwidth of 12.96 GHz may be used as a result of aggregating two bonded channels. A pattern 8 is a channel aggregation pattern that uses all of the six single channels and is a pattern (3ch+3ch) for aggregating two bonded channels each in which three single channels are bonded. The pattern 8 may reduce a number of RF chains compared to the pattern 7.

The above channel aggregation patterns are provided as examples only and various channel aggregation patterns may be used.

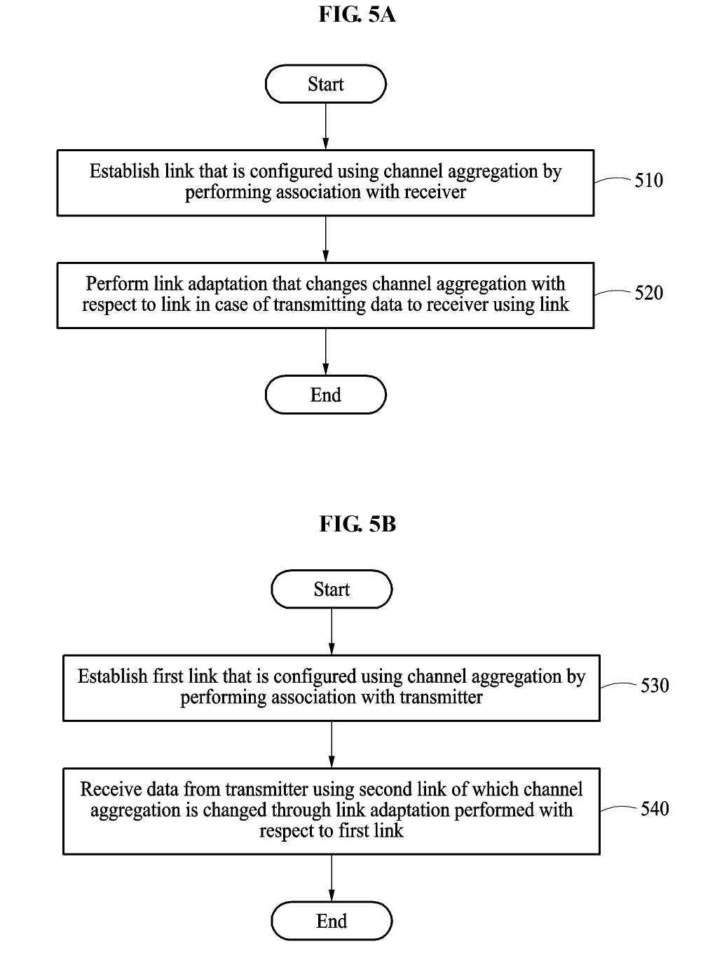

FIG. 5A is a flowchart illustrating a proximity communication method by a transmitter for changing a channel aggregation by performing a link adaptation according to an example embodiment.

Referring to FIG. 5A, in operation 510, the transmitter may establish a link that is configured using a channel aggregation by performing an association with a receiver. The channel aggregation may be performed based on a channel aggregation pattern that is selected to be suitable for an initial communication environment from among various channel aggregation patterns.

In operation 520, in the case of transmitting data to the receiver using the link, the transmitter may perform a link adaptation that changes the channel aggregation with respect to link. In a data transmission phase, the initial communication environment may be changed and the channel aggregation pattern may not be suitable for the changed communication environment. The transmitter may adjust a transmission rate to be suitable for the changed communication environment by performing the link adaptation that changes the channel aggregation pattern in the data transmission phase.

According to an example embodiment, the transmitter may perform the adaptation by changing a spreading factor (SF). For example, the spreading factor may be a value set to correspond to a value of an SFD field of a preamble included in a PHY frame of an OOK modulation scheme. The value of the SFD field may correspond to an MCS indicating the spreading factor.

According to another example embodiment, the transmitter may perform the link adaptation by changing a number of frequency segments. Here, the frequency segment indicates a continuous frequency block corresponding to a single channel or a single bonded channel that is a target of channel aggregation. If the communication environment becomes worse, the transmitter may increase a data transmission rate by increasing the number of frequency segments.

FIG. 5B is a flowchart illustrating a proximity communication method by a receiver for changing a channel aggregation by performing a link adaptation according to an example embodiment.

Referring to FIG. 5B, in operation 530, the receiver may establish a first link that is configured using a channel aggregation by performing an association with the transmitter. In operation 540, the receiver may receive data from the transmitter using a second link of which the channel aggregation is changed through the link adaptation performed with respect to the first link.

The link adaptation may be performed by changing a spreading factor or by changing a number of frequency segments. In the link adaptation performed by changing the spreading factor, the changed spreading factor may be known to the receiver through a value of an SFD field indicating the spreading factor and a channel aggregation pattern. The receiver may receive and decode a corresponding frame using a spreading factor corresponding to an SFD value of a transmission frame. In the link adaptation performed by changing the number of frequency segments, the number of frequency segments may be known to the receiver through a value of an SFD field indicating a channel aggregation pattern that indicates the number of frequency segments. The receiver may receive and decode a corresponding frame using a channel aggregation pattern corresponding to an SFD value of a transmission frame.

Once a frame is received, the receiver may initially decode a preamble in the frame transmitted using a frequency segment including a default channel. The receiver may acquire information associated with a channel aggregation pattern of a channel aggregation that is changed based on a changed value of an SFD field acquired as a decoding result. Using information associated with the channel aggregation pattern, the receiver may receive a data portion that is transmitted using the frequency segment including the default channel and a data portion that is transmitted using remaining frequency segments.

For example, the receiver may be aware of channels used for the channel aggregation pattern from the channel aggregation pattern that is disclosed in an SFD field of a preamble in the frame transmitted using the frequency segment including the default channel. The receiver may receive and decode a data portion to be transmitted using the frequency segment including the default channel and a data portion to be transmitted using frequency segments corresponding to a second channel or a third channel used for a channel aggregation.

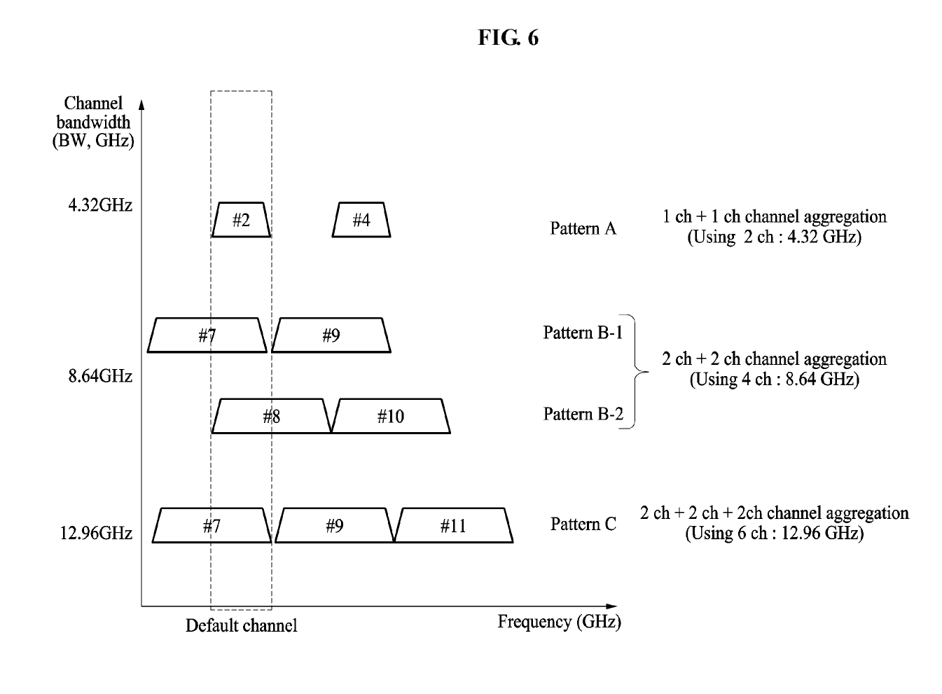

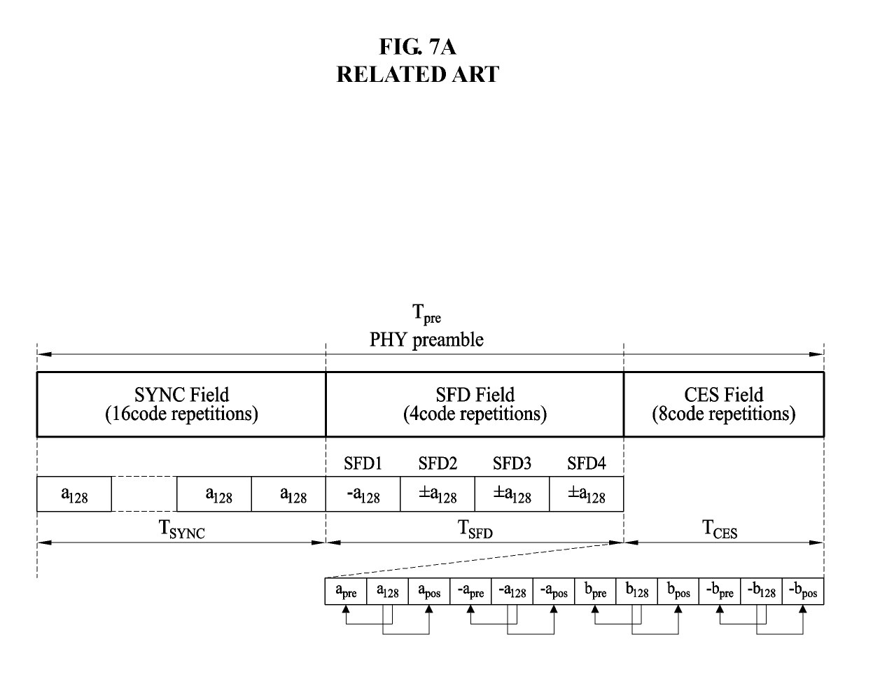

FIG. 6 illustrates a type of a channel aggregation pattern according to an example embodiment.

According to an example embodiment, a transmitter and a receiver may perform a proximity communication using a channel aggregation of various channel aggregation patterns. Single channels may be aggregated or bonded channels each in which two single channels are bonded may be aggregated by the channel aggregation. If the performance degradation is not great, bonded channels each in which three single channels are bonded may be aggregated.

Various types of channel aggregation patterns will be described with reference to FIG. 6. All the channel aggregation patterns may include a predetermined default channel. For example, if a channel 2 is set as the default channel, all of the channel aggregation patterns may include the channel 2. Once a channel aggregation pattern to be used between two terminals is determined, a scheme of aggregating channels for data transmission may be determined without performing a separate negotiation process and signaling. As described above, since channels to be used for the channel aggregation may be determined based on a channel aggregation pattern to be used, additional signaling overhead regarding a scheme of aggregating and using which channels may be reduced. For example, when a communication range is assumed to be less than 10 cm, all of the channels between two terminals, for example, a kiosk and a user terminal, may be assumed to be available at all times. Accordingly, the above method may be used without decreasing a channel use efficiency.

A pattern A is a channel aggregation pattern (1 ch+1 ch) in which a channel aggregation is performed on two single channels and a bandwidth of 4.32 GHz may be used. The pattern A may reduce interference between channels by aggregating non-adjacent single channels.

A pattern B-1 and a pattern B-2 represent a pattern (2 ch+2 ch) in which a channel aggregation is performed on two bonded channels each in which two single channels are bonded. In a country that allows only four channels, a pattern B-2 may not be used. In the case of performing the channel bonding with respect to two single channels, the existing OOK PHY may use a channel 8. Thus, the pattern B-2 may be easily implemented from the existing OOK PHY.

If an OOK modulation scheme performs the channel bonding, a performance degradation occurring in a data transmission may be insignificant without performing FDE up to a case in which a number of single channels to be bonded is two. Accordingly, a complexity issue occurring by performing complex FDE may be reduced. As described above, in the case of transmission using four channels, a relatively excellent transmission performance may be achieved without performing a complex processing, such as FDE, when a channel aggregation (2 ch+2 ch) is applied to two bonded channels each in which two single channels are bonded rather than when using a single bonded channel in which four single channels are bonded.

A pattern C is a method of using all of six single channels and refers to a case of performing a channel aggregation on three bonded channels each in which two single channels are bonded. Since the performance degradation may be insignificant without FDE up to bonding of two channels, a relatively excellent performance may be achieved without performing a complex processing such as FDE, rather than using a single bonded channel in which six single channels are bonded.

The above channel aggregation patterns are provided as examples only and various channel aggregation patterns may be used.

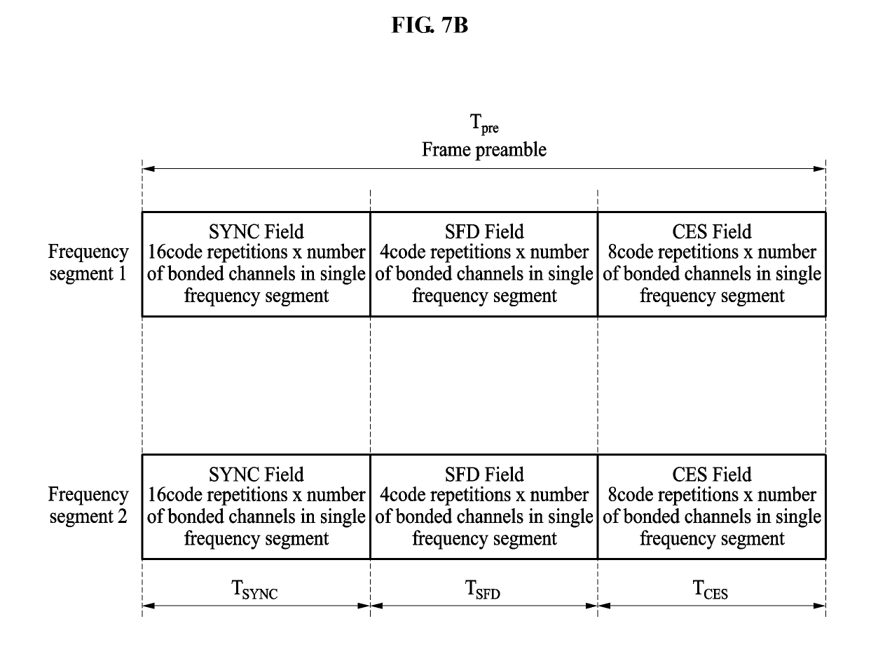

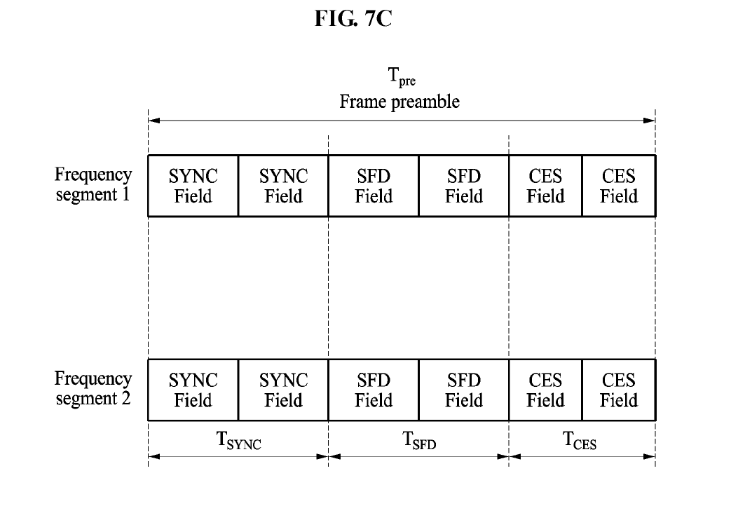

FIG. 7A illustrates a structure of a preamble according to the related art.

A structure of a preamble of an OOK PHY frame of the existing 802.15.3e technique will be described with reference to FIG. 7A. Referring to FIG. 7A, the preamble includes a channel estimation sequence (CES) field, an SFD field, and a frame synchronization (SYNC) field.

The SYNC field includes information associated with synchronization and is used for frame detection.

The CES field is used for channel estimation. The CES field may include, for example, Golay sequences a₁₂₈, −a₁₂₈, b₁₂₈, and −b₁₂₈. Here, a cyclic prefix, that is, a duplicate of last 64 bits of a sequence may be added in front of each sequence and a cyclic postfix, that is, a duplicate of first 64 bits of a sequence may be added at the back of each sequence.

The SFD field is used for a frame timing associated with a start of a PHY frame, and to inform a bandwidth, an MCS, and a number of channels used for channel bonding.

The transmitter may spread a frame by repeating a bit based on a spreading factor. The spreading factor may be 1, 2, or more. The transmitter may modulate the spread frame using an OOK scheme. The transmitter may transmit the modulated frame to the receiver at a predetermined chip rate. Each field of the preamble may be transmitted in order of the SYNC field, the SFD field, and the CES field.

For example, Table 1 shows a₁₂₈ and b₁₂₈ that are 128-bit Golay sequences. Each of fields of the preamble, that is, the SYNC field, the SPD field, and the CES field, may be configured as 128-bit Golay sequences

TABLE 1

| Sequence name | Sequence value |
|---|---|
| a₁₂₈ | 0x0536635005C963AFFAC99CAF05C963AF |
| b₁₂₈ | 0x0A396C5F0AC66CA0F5C693A00AC66CA0 |

According to an example embodiment, the SYNC field may be configured using the Golay sequence a₁₂₈ and may use 16 code repetitions for robustness. The SFD field may be configured using the Golay sequences a₁₂₈ and b₁₂₈, and 4 code repetitions. The CES field may be configured using 8 codes.

According to an example embodiment, the SFD field may include a value indicating a channel aggregation pattern of a channel aggregation. Referring to Table 2-1 and Table 2-2, the SFD field may include a value indicating a channel aggregation pattern using a reserved area of the SFD field of the OOK PHY frame disclosed in the existing 802.15.3e technique. Table 2-1 indicates SFD values that may be set in the case when the channel aggregation pattern described in FIG. 4c is used. Table 2-2 indicates SFD values that may be set in the case when the channel aggregation pattern described in FIG. 6 is used.

Referring to Table 2-1 and Table 2-2, if OOK MCS≥8, it corresponds to a structure expanded to represent the channel aggregation pattern.

Also, an SFD value may be set as shown in the following Table 2-2 to indicate whether the spreading factor of the frame transmitted using the channel aggregation pattern is 1 or 2. In Table 2-1 and Table 2-2 the SFD is expanded using the reserved area of the SFD field of the OOK PHY frame disclosed in the existing 802.15.3e.

TABLE 2-1

| SFD pattern | |
|---|---|
| (SFD2, SFD3, SFD4) | OOK MCS |
| +a +a +a | 0 (1 channel, SF = 1) |
| +a +a −a | 1 (2 channel bonding, SF = 2) |
| +a −a +a | 2 (2 channel bonding, SF = 1) |
| +a −a −a | 3 (3 channel bonding, SF = 2) |
| −a +a +a | 4 (3 channel bonding, SF = 1) |
| −a +a −a | 5 (4 channel bonding, SF = 2) |
| −a −a +a | 6 (4 channel bonding, SF = 1) |
| −a −a −a | 7 Reserved |
| +b +b +b | 8 (channel aggregation 1) |
| +b +b −b | 9 (channel aggregation 2) |
| +b −b +b | 10 (channel aggregation 3) |
| +b −b −b | 11 (channel aggregation 4) |
| −b +b +b | 12 (channel aggregation 5) |
| −b +b −b | 13 (channel aggregation 6) |
| −b −b +b | 14 (channel aggregation 7) |
| −b −b −b | 15 (channel aggregation 8) |

TABLE 2-2

| SFD pattern | |
|---|---|
| (SFD2, SFD3, | |
| SFD4) | OOK MCS |
| +a +a +a | 0 (1 channel, SF = 1) |
| +a +a −a | 1 (2 channel bonding using channel #8 and SF = 2) |
| +a −a +a | 2 (2 channel bonding using channel #8 and SF = 1) |
| +a −a −a | 3 (3 channel bonding, SF = 2) |
| −a +a +a | 4 (3 channel bonding, SF = 1) |
| −a +a −a | 5 (4 channel bonding, SF = 2) |
| −a −a +a | 6 (4 channel bonding, SF = 1) |
| −a −a −a | 7 (2 channel bonding using channel #7 and SF = 1) |
| +b +b +b | 8 (channel aggregation pattern A, SF = 2) |
| +b +b −b | 9 (channel aggregation pattern A, SF = 1) |
| +b −b +b | 10 (channel aggregation pattern B-1, SF = 2) |
| +b −b −b | 11 (channel aggregation pattern B-1, SF = 1) |
| −b +b +b | 12 (channel aggregation pattern B-2, SF = 2) |
| −b +b −b | 13 (channel aggregation pattern B-2, SF = 1) |
| −b −b +b | 14 (channel aggregation pattern C, SF = 2) |
| −b −b −b | 15 (channel aggregation pattern C, SF = 1) |

A method of indicating an MCS, a number of bonded channels, and a channel aggregation pattern using the SFD field may be the same as shown in Table 2-1. The transmitter may inform the receiver of the spreading factor, the channel aggregation pattern, and the number of channels to be used for channel bonding, using SFD2, SFD3, and SFD4 patterns. The receiver may receive information included in SFD2, SFD3, and SFD4, and may know in advance the channel aggregation pattern that is used by the transmitter before receiving a subsequent portion of the PHY frame. Through this, the receiver may prepare to receive a data frame. The transmitter may perform signaling of related information in advance using the SFD field. Thus, a number of bits indicating MCS related information of a header of the PHY frame may be reduced.

Table 2-1 is provided as an example only and the SFD field may be set using various methods about various channel aggregation patterns. The same SFD field value may be duplicated to each frequency segment.

A method of indicating an MCS, a number of bonded channels, a channel aggregation pattern, and a spreading factor (SF) using the SFD field may be the same as shown in Table 2-2. The transmitter may inform the receiver of the spreading factor, the channel aggregation pattern, and the number of channels to be used for channel bonding, using SFD2, SFD3, and SFD4 patterns. Referring to Table 2-2, if OOK MCS≥8, it corresponds to a structure expanded to represent the channel aggregation pattern. Also, although the existing OOK PHY uses only channel 8 for 2 channel bonding, the MCS 7 is added to enable 2 channel bonding using the channel 7.

The receiver may receive information included in SFD2, SFD3, and SFD4, and may know in advance the channel aggregation pattern that is used by the transmitter to transmit a corresponding PHY frame before receiving a subsequent portion of the PHY frame. Through this, the receiver may prepare to receive a data frame. The transmitter may perform signaling of related information in advance using the SFD field. Thus, a number of bits indicating MCS related information of a header of the PHY frame may be reduced.

Referring to Table 2-2, if OOK MCS=1 or 2, the channel 8 may be used for 2 channel bonding. If OOK MCS=7, the channel 7 may be used for the 2 channel bonding. If OOK MCS≥8, it may indicate the channel aggregation pattern. However, Table 2-2 is provided as an example only and the SFD field may be set using various methods about various channel aggregation patterns. The same SFD field value may be duplicated to each frequency segment.

According to an example embodiment, the transmitter may perform a link adaptation by changing a spreading factor in a data transmission phase. When transmitting a frame, the transmitter may inform the receiver of a changed spreading factor by setting an SFD field value indicating a spreading factor and a channel aggregation pattern of the corresponding frame as a value corresponding to the changed spreading factor, so that the receiver may receive and decode the corresponding frame using the changed spreading factor.

Since Information associated with an added channel aggregation pattern and spreading factor is represented using a reserved area of the SFD field of the OOK PHY frame of the existing 802.15.3e technique. Thus, there is no need to change a PHY frame structure of the 802.15.3e technique.

Signaling of the spreading factor may be performed through a preamble of the PHY frame. Accordingly, the receiver may verify the spreading factor applied to the corresponding frame through the preamble and then may receive and decode the PHY frame by applying the corresponding spreading frame to the PHY frame. Accordingly, a separate additional negotiation about a spreading factor is not required.

FIG. 7B illustrates a structure of a preamble based on a channel aggregation according to an example embodiment.

A transmitter and a receiver may perform a proximity communication using a preamble expanded for a channel aggregation. The preamble according to an example embodiment may be provided in a format that is expanded from a preamble structure disclosed in 802.15.3e technique.

The preamble may be included in each of frequency segments corresponding to the respective single channels or bonded channels aggregated by the channel aggregation. Once the channel aggregation is performed, the preamble may be duplicated to each frequency segment. A PHY header and a PHY payload provided after the preamble in the PHY frame may be transmitted using all of the frequency segments.

For example, if two frequency segments are used, an even bit of the frame to be transmitted may be transmitted through a first frequency segment and an odd bit may be transmitted through a second frequency segment. Here, the frequency segment denotes a consecutive frequency block corresponding to a single channel or a single bonded channel that is a target of the channel aggregation.

Once the channel bonding is applied, an amount of time used when the receiver receives the preamble may decrease according to an increase in a data rate. The transmitter may repeat a specific field within the PHY frame so that the receiver may robustly process the preamble. For example, in the case of bonding two channels, a CES field may be repeated so that 8 code repetitions may appear twice consecutively. An SFD field may be repeated so that 4 code repetitions may appear twice consecutively. An SYNC field may be repeated so that 16 code repetitions may appear twice consecutively.

The transmitter may repeat the specific field a number of times corresponding to a number of bonded channels. Through this, a reception time used to transmit the preamble using a single channel to which a channel bonding is not applied may be maintained to be the same as a reception time used to transmit the preamble using a bonded channel. For example, the reception time of the preamble may be the same with respect to all of a single channel, 2 channel bonding, 3 channel bonding, and 4 channel bonding. Referring to FIG. 7B, T_{SYNC}, T_{SFD}, and T_{CES} are identical to T_{SYNC}, T_{SFD}, and T_{CES} to which channel bonding is not applied, and Tₚᵣₑ (=T_{SYNC}+T_{SFD}+T_{CES}) is identical to Tₚᵣₑ (=T_{SYNC}+T_{SFD}+T_{CES}) to which channel bonding is not used.

However, it is provided as an example only and the preamble may be provided in various formats based on a channel aggregation pattern.

A center frequency needs to be changed to change a number of channels used for channel bonding in the existing 802.15.3e technique. Once the transmitter changes the number of channels used for the channel bonding and thereby transmits the frame, the center frequency of the corresponding frame is changed. Thus, the preamble of the corresponding frame may not be decoded properly and the frame may not be received. Accordingly, in the case of using the channel bonding of the existing 802.15.3e technique, a channel switch and bandwidth change procedure through an additional MAC frame exchange needs to be performed in the data transmission phase in order to adjust a bandwidth by adjusting the number of channels to be used.

On the contrary, even in the data transmission phase, the link adaptation according to an example embodiment may be performed by changing a number of frequency segments used for transmission without performing the channel switch and bandwidth change procedure through the separate additional MAC frame exchange. The number of frequency segments is defined in a channel aggregation pattern. Thus, when the transmitter changes the number of frequency segments used for transmission, the transmitter may inform the receiver of the changed number of frequency segments by setting a value of the SFD field indicating a channel aggregation pattern as a channel aggregation pattern corresponding to the changed number of frequency segments, so that the receiver may receive and decode the corresponding frame. The link adaptation according to an example embodiment may adjust a bandwidth without performing a separate additional bandwidth negotiation since the number of frequency segments is changed. The number of frequency segments may decrease and conversely, may increase based on a result of the link adaptation.

For example, if a channel state is deteriorated or a frequency of an acknowledgement (ACK) frame transmitted from the receiver decreases while data is being transmitted using 2 ch+2 ch channel aggregation, the transmitter may decrease a data transmission rate by reducing the number of frequency segments used for data transmission.

Through the link adaptation, a link that is configured using a channel aggregation of a first bonded channel and a second bonded channel may be changed with a link that is configured using the first bonded channel. For example, the transmitter may change a channel aggregation pattern while transmitting data through two frequency segment using the 2 ch+2 ch channel aggregation, and may transmit the frame through a single frequency segment using only a single channel 7 that is a 2 ch bonded channel. Since the receiver continuously listens to a default channel, the receiver may decode a preamble of the channel 7. The receiver may determine that the data transmission is performed using only a single 2 ch based on information associated with the channel aggregation pattern that is included in the preamble.

When the transmitter reduces a bandwidth by using only a channel 8 that is a 2ch bonded channel while using the channel aggregation pattern B-2 of FIG. 6, the transmitter may perform signaling by setting a value of the SFC field to +a+a-a or +a-a+a as in the channel bonding in which two single channels are bonded. In this case, an SFD value, a preamble, and a PHY frame structure may be identical to an SFD value, a preamble, and a PHY frame structure of channel bonding in which two single channels are bonded in the existing 802.15.3e technique. Accordingly, the above method may be employed although the transmitter exchanges data with the receiver that does not support the channel aggregation and supports only the existing 802.15.3e technique using the channel bonding in which two single channels are bonded.

When the transmitter reduces the bandwidth by using only the channel 7 that is a 2 ch bonded channel while using the channel aggregation pattern B-1 of FIG. 6, the transmitter may perform signaling by setting a value of the SFD field as −a−a−a. In this case, due to incompatibility with the channel bonding in which two single channels are bonded in the existing 802.15.3e technique, the transmitter may not exchange data with the receiver that does not support the channel aggregation and supports the existing 802.15.3e technique using the channel bonding in which two single channels are bonded.

Through the link adaptation, a link that is configured using a channel aggregation of a first single channel and a second single channel may be changed with a link that is configured using the second single channel. When the transmitter transmits data using only a single channel configured using a default channel while transmitting data using channel aggregation of 1 ch+1 ch, the receiver may initially decode a preamble that is received using the default channel. The receiver may verify a channel being used from a changed SFD field and may decode a frame that is received using the verified channel.

For example, when the transmitter transmits data through a single channel using only the channel 2 that is the default channel while transmitting data using 1 ch+1 ch channel aggregation in a data transmission phase, the transmitter may perform signaling by setting a value of the SFD field as +a+a+a. In this case, an SFD value, a preamble, and a PHY frame structure may be identical to an SFD value, a preamble, and a PHY frame structure of a single channel transmission of the existing 802.15.3e technique. Accordingly, in this case, the transmitter may exchange data with the receiver that does not support the channel aggregation and supports the existing 802.15.3e technique using only the single channel.

Through the link adaptation, a link that is configured using a channel aggregation of a first bonded channel, a second bonded channel, and a third bonded channel may be changed with a link that is configured using a channel aggregation of the first bonded channel and the second bonded channel or a link that is configured using the first bonded channel. When the transmitter changes a channel aggregation pattern while transmitting data using channel aggregation of 2 ch+2ch+2 ch, the receiver may decode a preamble received through the channel 7 that includes the default channel. The receiver may determine whether the preamble is transmitted through a single bonded channel using the channel 7, transmitted through a channel aggregation using the channel 7 and channel 9, or transmitted through a channel aggregation using the channel 7, the channel 9, and channel 11, based on the SFD value acquired through decoding.

For example, in the case of changing the channel aggregation pattern with the channel aggregation using the channel 7 and the channel 9 through the link adaptation, the transmitter may set a value of the SFD field as +b−b+b or +b−b−b. In this case, an SFD value, a preamble, and a PHY frame structure are completely identical to those of transmission using the pattern B-1 of FIG. 6.

For example, in the case of reducing a bandwidth with a bonded channel using only the channel 7 through the link adaptation, the transmitter may set a value of the SFD field as −a−a−a, and may perform signaling so that the receiver may use only a single channel.

FIG. 7C illustrates a structure of a preamble based on a channel aggregation using a bonded channel according to an example embodiment.

In the case of aggregating bonded channels, a preamble may be repeated a number of times corresponding to a number of single channels bonded in each bonded channel in each frequency segment. For example, in the case of 2ch+2ch channel aggregation, two frequency segments are used. A structure of a preamble of each frequency segment may be identical to a structure of a preamble of a bonded channel in which two single channels are bonded. In each frequency segment, the preamble of the bonded channel in which two single channels are bonded may be provided in a structure in which each of a CES field, an SYNC field, and an SFD field is repeated twice.

In the case of 1ch+1ch channel aggregation, each frequency segment may use the same preamble as that of transmission using a single channel transmission. In the case of 3ch+3ch channel aggregation, each frequency segment may use the same preamble as that of transmission using a single bonded channel in which three single channels are bonded. In the case of 2ch+2ch+2ch channel aggregation, the same preamble as that of transmission using the single bonded channel in which two single channels are bonded may be duplicated to each of the three frequency segments (2ch+2ch+2ch).

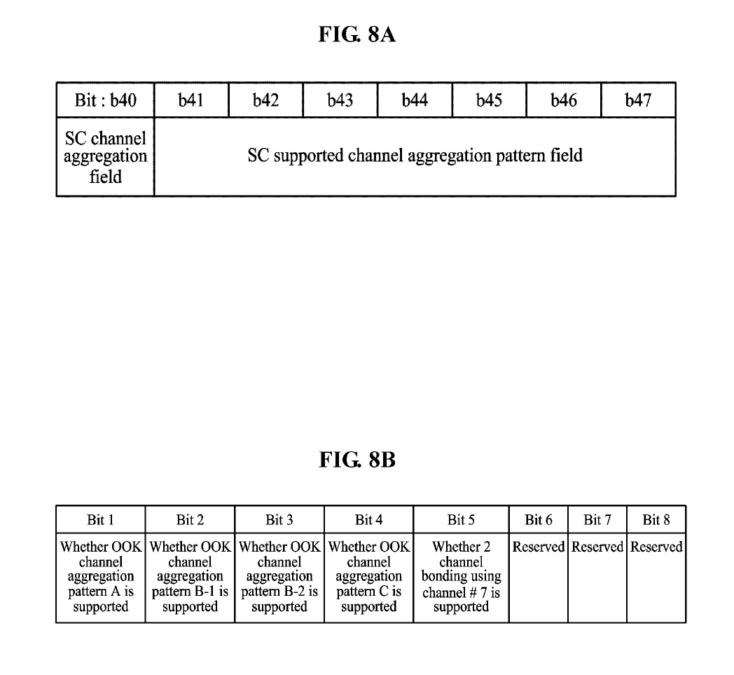

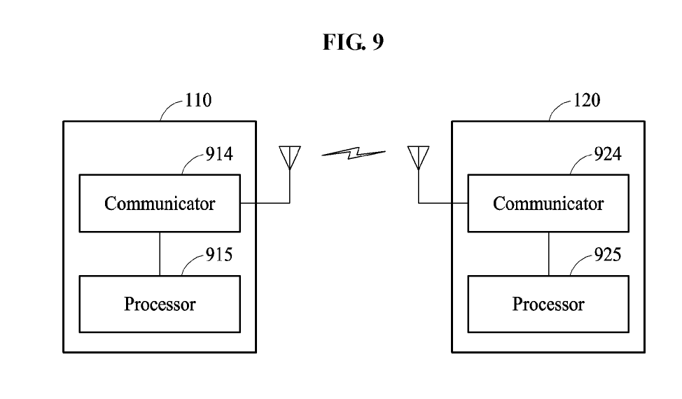

FIG. 8A illustrates a structure of a single-carrier (SC) channel aggregation field and an SC supported channel aggregation pattern field according to an example embodiment.

According to an example embodiment, a transmitter may transmit, to a receiver, information regarding whether a channel aggregation is supported and information associated with channel aggregation patterns supported by the transmitter. The transmitter may perform a proximity communication with the receiver by informing the receiver of information regarding whether the channel aggregation is supported and the channel aggregation patterns being supported, and by selecting a single channel aggregation pattern from among the channel aggregation patterns that are commonly supported by the transmitter and the receiver, during an association process. If a link adaptation is required due to a change in a channel environment, the transmitter may increase or decrease a bandwidth by selecting a suitable channel aggregation pattern.

To inform a counterpart terminal of information regarding whether the channel aggregation is supported and channel aggregation patterns being supported during the association process, the transmitter and the receiver may reuse an SC channel aggregation field and an SC supported channel aggregation pattern field included in a PRC capability information element (IE), a PRDEV capability IE, or a pairnet operation parameters (IE) of the existing 802.15.3e technique.

The structure of the SC channel aggregation field and the SC supported channel aggregation pattern field will be described with reference to FIG. 8A. In the case of OOK PHY of the existing 802.15.3e technique, all of the fields associated with an SC PHY frame among fields of the PRC Capability IE, the PRDEV capability IE, or the pairnet operation parameters IE may be set to 0. A terminal that supports only the existing OOK PHY does not decode fields associated with the SC PHY frame. According to an example embodiment, the transmitter may indicate whether the transmitter or the receiver using PHY of an OOK modulation scheme supports a channel aggregation or uses the channel aggregation and a channel aggregation pattern that is supported or used by the transmitter or the receiver, based on SC related fields that are not used in OOK PHY of the existing 802.15.3e technique.

The transmitter may transmit, to the receiver, information regarding whether the channel aggregation is supported and information associated with a channel aggregation pattern using the SC channel aggregation field and the SC supported channel aggregation pattern field. Example embodiments may vary based on a case in which the SC channel aggregation field and the SC supported channel aggregation pattern field are included in the pairnet operation parameters IE and a case in which the SC channel aggregation field and the SC supported channel aggregation pattern field are included in the PRC capability IE or the PRDEV capability IE.

When the SC channel aggregation field and the SC supported channel aggregation pattern field are included in the pairnet operation parameters IE, the SC channel aggregation field and the SC supported channel aggregation pattern field may be used to inform which channel aggregation pattern is determined to be used in a current data transmission phase. During the association process, the transmitter may verify capability information of the transmitter and the receiver, and may determine a parameter to be used in the data transmission phase. Here, if SC supported channel aggregation pattern field=1, it may indicate that the channel aggregation is used. If a specific field of the SC supported channel aggregation pattern field is set to be 1, it may indicate that a channel aggregation pattern corresponding to the specific field is used.

For example, the pattern B-1, the pattern C, and a channel bonding using the channel 7 and in which two single channels are bonded may be simultaneously used while changing a bandwidth. Accordingly, bits corresponding to the pattern B-1, the pattern C, and the channel bonding may be simultaneously set to 1.

For example, if a bit is set to use the pattern B-2, the corresponding bit may be set in the existing OOK supported channel bonding field so that the channel bonding in which the two single channels are bonded is used.

The above signaling scheme enables compatibility with a terminal using only the existing OOK PHY standard that does not support a channel aggregation.

FIG. 8B illustrates a structure of an SC supported channel aggregation pattern field according to an example embodiment.

When the SC channel aggregation field and the SC supported channel aggregation pattern field are included in the PRC capability IE or the PRDEV capability IE, the SC channel aggregation field may indicate whether the transmitter or the receiver supports the channel aggregation of the OOK modulation scheme and the SC supported channel aggregation pattern field may indicate a scheme of the channel aggregation of the OOK modulation scheme that is supported by the transmitter or the receiver.

When the transmitter or the receiver does not support the channel aggregation of the OOK modulation scheme, the transmitter or the receiver may set the SC channel aggregation field to be 0 and may set the SC supported channel aggregation pattern field to be 0. Referring to FIG. 8B, all of bits 1, 2, 3, and 4 may be set to be 0.

When the transmitter or the receiver supports the channel aggregation of the OOK modulation scheme, the transmitter or the receiver may set the SC channel aggregation field to be 1 and may set bits corresponding to the channel aggregation pattern supported by the transmitter or the receiver among bits of the SC supported channel aggregation pattern field to be 1.

When the transmitter or the receiver uses the channel bonding including the channel 7, whether the channel bonding including the channel 7 is used may not be signaled to a counterpart terminal using the OOK supported channel bonding field of the existing 802.15.3e technique. Thus, the transmitter or the receiver may signal, to the counterpart terminal, whether the channel bonding including the channel 7 is used using bit 5 of the SC supported channel aggregation pattern field.

When the transmitter or the receiver supports the pattern B-2, the transmitter or the receiver may set a corresponding bit of the SC supported channel aggregation pattern field to be 1, and, at the same time, may indicate that channel bonding in which two single channels are bonded is used using the existing OOK supported channel bonding field. Through this, an existing OOK PHY terminal that does not support the channel aggregation may perform a proximity communication through the channel bonding in which the two single channels are bonded by decoding only the OOK supported channel bonding field, which may lead to enhancing the compatibility.

FIG. 9 is a diagram illustrating a configuration of a transmitter and a receiver according to an example embodiment.

Referring to FIG. 9, the transmitter 110 and the receiver 120 may perform a proximity communication using a link that is configured, that is, associated, using a channel aggregation. The transmitter 110 includes a communicator 914 and a processor 915. The receiver 120 includes a communicator 924 and a processor 925.

A channel aggregation pattern may be selected from among various combinations of single channels, and may also be selected from among various combinations of bonded channels each in which single channels are bonded. The transmitter 110 may establish a link through an association process before transmitting data and may inform the receiver 120 of the channel aggregation pattern.

The processor 915 transmits a beacon frame to the receiver 120 through the communicator 914 and a default channel. The beacon frame may include information associated with the channel aggregation pattern supported by the corresponding transmitter 110.

The communicator 924 may receive the beacon frame from the transmitter 110. The communicator 924 may transmit an association request signal to the transmitter 110. The association request signal may include information associated with a channel aggregation pattern supported by the corresponding receiver 120.

The communicator 914 may receive the association request signal from the receiver 120. The transmitter 110 and the receiver 120 may perform an association process. The transmitter 110 and the receiver 120 may establish a link that is configured using the channel aggregation. The receiver 120 may prepare to receive data based on the verified channel aggregation pattern signaled by a SFD value included in the preamble of the received frame.

The processor 915 may establish a link that is configured using the channel aggregation by performing an association with the receiver 120 through the communicator 914. When the communicator 914 transmits data to the receiver 120 using the link, the processor 915 may perform a link adaptation with respect to the link to change the channel aggregation to be suitable for a communication environment.

The processor 915 may perform the link adaptation by changing a spreading factor and may also perform the link adaptation by changing a number of frequency segments.

The processor 925 may decode the received preamble using the frequency segment including the default channel through the communicator 924 and may verify information associated with the changed channel aggregation. The processor 925 may receive and decode data that is received through frequency segments used for a subsequent frame transmission based on information associated with the changed channel aggregation.

The example embodiments described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A proximity communication method by a transmitter, the method comprising:
transmitting a beacon frame to a receiver using a default channel; and
establishing a link that is configured using a channel aggregation by performing an association with the receiver in response to receiving an association request signal from the receiver.

2. The method of claim 1, wherein a first single channel and a second single channel are aggregated by the channel aggregation.

3. The method of claim 1, wherein a first bonded channel and a second bonded channel are aggregated by the channel aggregation and the first bonded channel and the second bonded channel are generated by bonding of two single channels.

4. The method of claim 1, wherein a first bonded channel, a second bonded channel, and a third bonded channel are aggregated by the channel aggregation, and the first bonded channel, the second bonded channel, and the third bonded channel are generated by bonding of two single channels.

5. The method of claim 1, wherein a fourth bonded channel and a fifth bonded channel are aggregated by the channel aggregation, and the fourth bonded channel and the fifth bonded channel are generated by bonding of three single channels.

6. The method of claim 1, wherein a preamble in the frame transmitted after the link establishment is included in each of frequency segments corresponding to the respective single channels or bonded channels aggregated by the channel aggregation.

7. The method of claim 6, wherein the preamble is repeated a number of times corresponding to a number of single channels used in the bonded channel in each of the frequency segments.

8. A proximity communication method by a transmitter, the method comprising:
establishing a link that is configured using a channel aggregation by performing an association with a receiver; and
performing a link adaptation that changes the channel aggregation with respect to the link in response to transmitting data to the receiver using the link.

9. The method of claim 8, wherein the performing of the link adaptation comprises performing the link adaptation by changing a spreading factor.

10. The method of claim 9, wherein the performing of the link adaptation comprises performing the link adaptation by changing a value of a start frame delimiter (SFD) field indicating a channel aggregation pattern and the spreading factor.

11. The method of claim 8, wherein the performing of the link adaptation comprises performing the link adaptation by changing a number of frequency segments.

12. The method of claim 11, wherein the performing of the link adaptation comprises changing the number of frequency segments by changing a value of an SFD field indicating a channel aggregation pattern that indicates the number of frequency segments.

13. The method of claim 11, wherein the performing of the link adaptation comprises changing a link that is configured using a channel aggregation of a first single channel and a second single channel with a link that is configured using the second single channel.

14. The method of claim 11, wherein the performing of the link adaptation comprises changing a link that is configured using a channel aggregation of a first bonded channel and a second bonded channel with a link that is configured using the first bonded channel.

15. The method of claim 8, wherein the performing of the link adaptation comprises changing a link that is configured using a channel aggregation of a first bonded channel, a second bonded channel, and a third bonded channel with a link that is configured using a channel aggregation of the first bonded channel and the second bonded channel or a link that is configured using the first bonded channel.

16. The method of claim 8, wherein the performing of the association comprises transmitting information regarding whether a channel aggregation is supported and information associated with a channel aggregation pattern to the receiver.

17. A non-transitory computer-readable recording medium storing instructions that, when executed by a processor, cause the processor to perform the proximity communication method of claim 1.

18. A proximity communication apparatus comprising:
at least one processor,
wherein the processor is configured to generate a link that is configured using a channel aggregation by performing an association with a receiver, and to perform a link adaptation that changes the channel aggregation with respect to the link in response to transmitting data to the receiver using the link.

19. The proximity communication apparatus of claim 18, wherein the processor is configured to perform the link adaptation by changing a spreading factor.

20. The proximity communication apparatus of claim 18, wherein the processor is configured to perform the link adaptation by changing a number of frequency segments.
